(19) United States
(12) Patent Application Publication
(10) Pub. No.: US 2026/0172821 A1
(43) Pub. Date: Jun. 18, 2026

(54) METHOD AND APPARATUS FOR WLAN SENSING PROTECTION

(71) Applicant: HUAWEI TECHNOLOGIES CO., LTD., Shenzhen (CN)

(72) Inventors: Michael Montemurro, Toronto (CA); Stephen McCann, Southampton (GB); Li Sun, Shenzhen (CN); Rui Du, Singapore (SG); Lei Huang, Singapore (SG); Gerile Naren, Shenzhen (CN); Rojan Chitrakar, Singapore (SG)

(73) Assignee: HUAWEI TECHNOLOGIES CO., LTD., Shenzhen (CN)

(21) Appl. No.: 19/462,540

(22) Filed: Jan. 28, 2026

Related U.S. Application Data
(63) Continuation of application No. PCT/CN2023/134177, filed on Nov. 25, 2023.

(51) Int. Cl. H04W 12/041; H04W 4/38; H04W 84/12

(52) U.S. Cl. CPC H04W 12/041; H04W 4/38; H04W 84/12

(57) ABSTRACT

There is provided a method for WLAN sensing protection. A symmetric key is established between an initiator and a responder. The symmetric key is used to parameterize a transformation function. When measurement signals are transmitted by the initiator, they are first transformed by the transformation function. When these measurement signals are received at the responder, the responder applies the inverse of the transformation function to the received signal. The responder may then analyze the received and transformed signal and provide a measurement report back to the initiator.

### OTHER APPLICATIONS

The present application is a bypass continuation of International Application No. PCT/CN2023/134177, filed Nov. 25, 2023.

### TECHNICAL FIELD

The present disclosure relates to Wireless Local Area Network (WLAN) sensing technology. Specifically, the present disclosure relates to a method of protecting privacy within a WLAN sensing application.

### BACKGROUND

IEEE 802.11bf is a task group within the IEEE 802.11 Wireless LAN project working on an extension standard to enable IEEE 802.11 devices to support WLAN sensing. WLAN sensing is the use, by a sensing capable station, of received WLAN signals to detect features of an object within the area covered by the WLAN.

WLAN sensing enables a sensing capable station to detect features such as range, velocity, rotation, motion, presence, proximity, and gestures. Objects that can be tracked using WLAN sensing include people, animals, or inanimate objects. The area covered by WLAN sensing may be a house, a room, a vehicle, or a commercial setting.

However, a passive observer may use WLAN sensing to obtain private information about the objects within an area covered by a WLAN. For example, an eavesdropper may analyze signals to obtain location information, living habits, behavioral biometric characteristics, heart rate, respiratory rate, and even the identity of persons within the area.

### SUMMARY

It is an object of the present disclosure to provide a method for negotiating privacy protection in WLAN sensing.

In a first aspect, there is provided a method at an initiator for Wireless Local Area Network (WLAN) sensing protection. The method comprises establishing a symmetric key with a responder; deriving a transformation function from the symmetric key; applying the transformation function to a signal; transmitting the signal; and receiving the measurement report from the responder based on the signal.

In a second aspect, there is provided a computing device comprising a processor and a communications subsystem. The processor and the communications subsystem cooperate to establish a symmetric key with a responder; derive a transformation function from the symmetric key; apply the transformation function to a signal; transmit the signal; and receive the measurement report from the responder based on the signal.

In a third aspect, there is provided a computer readable medium having stored thereon executable code for execution by a processor of an initiator device. The executable code comprises instructions for establishing a symmetric key with a responder; deriving a transformation function from the symmetric key; applying the transformation function to a signal; transmitting the signal; and receiving the measurement report from the responder based on the signal.

By transforming signals prior to transmission, eavesdroppers may not analyze the WLAN sensing signals, thereby protecting the privacy of the WLAN sensing target. The authorized responder may apply the inverse of the transformation function to the received signals in order to analyze the WLAN sensing signals.

According to a first implementation of the first aspect, the second aspect, or the third aspect, the symmetric key is established by transmitting a first nonce and a key size to the responder; receiving a second nonce from the responder; and deriving the symmetric key having the key size from the first nonce and the second nonce.

The symmetric key may be established based on a nonce from the initiator and a nonce from the responder. The initiator may also indicate a key size.

According to a second implementation of the first aspect, the second aspect, or the third aspect, the symmetric key is established by computing a symmetric key at the initiator, and transmitting the symmetric key to the responder.

The symmetric key may be established by the initiator computing a key, and sharing it with the responder.

According to a third implementation of the first aspect, the second aspect, or the third aspect, the transformation function is a constellation rotation function, wherein the amount of rotation is a function θₖ(t) of a time.

The transformation function may be a constellation rotation function. The constellation rotation function varies over time such that different rotations are applied at different time intervals.

According to a fourth implementation of the first aspect, the second aspect, or the third aspect, the θₖ(t) function is parameterized using M values extracted from the symmetric key, where M is an integer known by the initiator and by the responder.

The θₖ(t) function is parameterized based on values extracted from the symmetric key. Therefore, knowledge of the symmetric key, and knowledge of the algorithm used to parameterize the θₖ(t) function from the symmetric key, allows both the initiator and the responder to have knowledge of the θₖ(t) function.

According to a fifth implementation of the first aspect, the second aspect, or the third aspect, M is selected by the initiator and transmitted to the responder.

The value of M may be transmitted by the initiator to the responder during setup.

According to a sixth implementation of the first aspect, the second aspect, or the third aspect, the value of M is predetermined.

The value of M may be predetermined and known by both the initiator and the responder.

According to a seventh implementation of the first aspect, the second aspect, or the third aspect, the M values are extracted from the symmetric key by selecting L bits from the symmetric key, wherein L is determined by dividing a length of the symmetric key in bits by M, to produce a first value; and by scaling the first value to a second value between 0 and 2π.

The M values used to parameterize the transformation function may be extracted by extracting M sets of bits of equal size from the symmetric key, and scaling the resulting number to a value between 0 and 2π.

According to an eighth implementation of the first aspect, the second aspect, or the third aspect, the method further comprises indicating, to the responder, WLAN sensing protection capabilities of the initiator.

The initiator may indicate its WLAN sensing protection capabilities to the responder to allow the initiator and the responder to agree to a WLAN sensing protection scheme.

### BRIEF DESCRIPTION OF THE DRAWINGS

The present disclosure will be better understood with reference to the drawings in which:

FIG. 1 is a graphical representation of an area in which WLAN sensing takes place.

FIG. 2 is a flow diagram illustrating a WLAN sensing protocol.

FIG. 3 is a graphical representation of an eavesdropper collecting private information using WLAN sensing.

FIG. 4 is a graphical representation of an exemplary rotation function θₖ(t).

FIG. 5 is a graphical representation of a simple WLAN sensing system.

FIG. 6 is a flow diagram illustrating a method for WLAN sensing protection according to at least one embodiment of the present disclosure.

FIG. 7 is a flow diagram illustrating a method for WLAN sensing protection according to at least one embodiment of the present disclosure.

FIG. 8 is a flow diagram illustrating a method for deriving M random values from a key according to at least one embodiment of the present disclosure.

FIG. 9 is a flow diagram illustrating a method for WLAN sensing protection according to at least one embodiment of the present disclosure.

FIG. 10 is a flow diagram illustrating a method for WLAN sensing protection according to at least one embodiment of the present disclosure.

FIG. 11 is a flow diagram illustrating a method for WLAN sensing protection according to at least one embodiment of the present disclosure.

FIG. 12 is a flow diagram illustrating a method for WLAN sensing protection according to at least one embodiment of the present disclosure.

FIG. 13A is an illustration of a Sensing Privacy Element according to at least one embodiment of the present disclosure.

FIG. 13B is an illustration of a Sensing Privacy Element according to at least one embodiment of the present disclosure.

FIG. 13C is an illustration of a Sensing Privacy Tuple according to at least one embodiment of the present disclosure.

FIG. 14 is a flow diagram illustrating a method for WLAN sensing protection according to at least one embodiment of the present disclosure.

FIG. 15 is a block diagram of an exemplary computing device for implementing embodiments of the present disclosure.

### DETAILED DESCRIPTION

The present disclosure is directed to a method and apparatus for protecting privacy in WLAN sensing applications.

Channel State Information (CSI) is used in IEEE 802.11 to support beam forming and it can also be used as an input to sensing. For example, in some applications of WLAN sensing, the CSI will vary over time and such variations may be used to detect intruders. In such cases, sensing requires regular CSI feedback. The CSI feedback over a given period may be highly correlated.

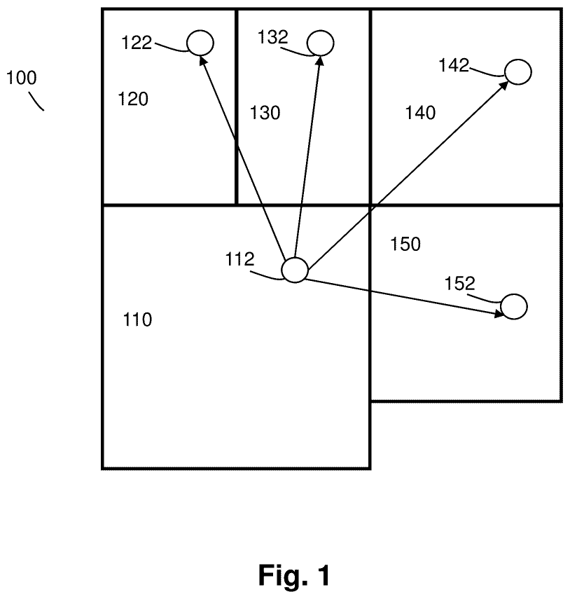

Reference is now made to FIG. 1, in which an area is set up with equipment for performing feedback sensing. Specifically, in FIG. 1, an area 100 comprises rooms 110, 120, 130, 140, and 150. Area 100 is provided for illustration only and is not intended to be limiting. Room 110 comprises an initiator 112. Within the context of the present disclosure, an initiator refers to a WLAN station that transmits Protocol Packet Data Units (PPDUs) used for sensing measurements.

As further seen in FIG. 1, room 120 includes responder 122, room 130 includes responder 132, room 140 includes responder 142, and room 150 includes responder 152. Within the context of the present disclosure, a responder refers to a WLAN station that receives PPDUs sent by an initiator and performs sensing measurements.

During operation, initiator 112 transmits PPDUs which are received by each of the responders 122, 132, 142, and 152. The responders 122, 132, 142, and 152 may then analyze the received PPDUs to perform WLAN sensing.

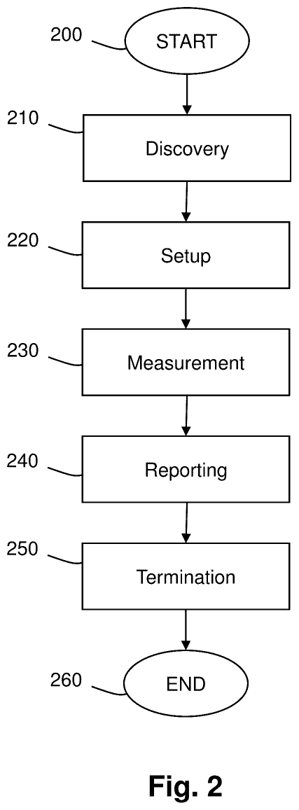

Reference is now made to FIG. 2, in which the IEEE 802.11bf sensing protocol is illustrated. As seen in FIG. 2, the process starts at block 200 and proceeds to block 210 in which discovery takes place. During discovery, the initiator and the responders become aware of each other's presence and each other's capabilities.

After discovery, the process moves on to block 220 for the setup phase. During setup, various parameters can be transmitted from the initiator to the responder within a Sensing Request frame. For example, a threshold parameter that allows responders to determine when received CSI variations indicate the motion of objects.

After setup, the process moves on to block 230 for the measurement phase. During measurement, a responder may receive PPDUs from the initiator and analyze characteristics of the received signal to make a determination with respect to a sensing target.

After measurement, the process moves on to block 240 for the reporting phase, in which measurement results are reported. For example, the measurement results may be reported to a client device, or to the initiator.

After reporting, the process moves on to block 250 for the termination phase, in which the sensing session is terminated. The termination of the session may be implicit or explicit. The process then ends at block 260.

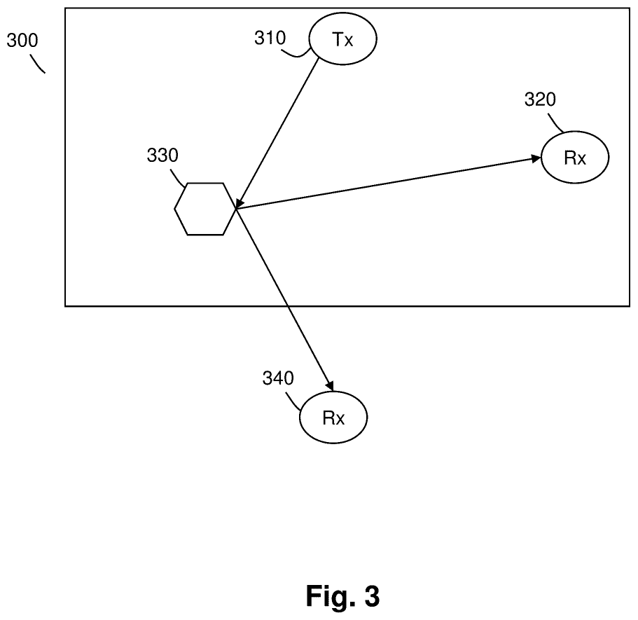

Based on the above, an eavesdropper may collect private information from analyzing signals emitted by an initiator, as illustrated with respect to FIG. 3.

Specifically, as seen in FIG. 3, an area 300 is served by an initiator 310 and a responder 320. The initiator may transmit signals which are interpreted by the responder 320 to collect information on target 330. Target 330 may be an inanimate object, or a person, and the information collected on target 330 may comprise, position, movement, heart rate, and the like. However, standing outside area 300 is eavesdropper 340, which despite being unauthorized may also analyze the signals transmitted by initiator 310 to obtain information on target 330. Notably, the eavesdropper may also be found within area 300 and the example of FIG. 3 is not intended to be limiting.

Accordingly, there is a need to protect WLAN sensing signals from being received and interpreted by such an unauthorized eavesdropper.

One solution for providing privacy protection in WLAN sensing consists in applying a rotation θ to a constellation waveform at the initiator. If the responder knows the rotation θ, the rotation may be removed by the responder prior to interpreting the signal. The rotation θ may be selected from a function of time, such that θₖ(t) produces a value θ for time t. The function θₖ(t) may be selected such that it varies slowly with time, thereby allowing a receiver to compute the correct value θ at the time a signal is received. An unauthorized receiver who does not have knowledge of the θₖ(t) function may not interpret signals correctly as it would be difficult for it to determine the correct value of θ for a given time.

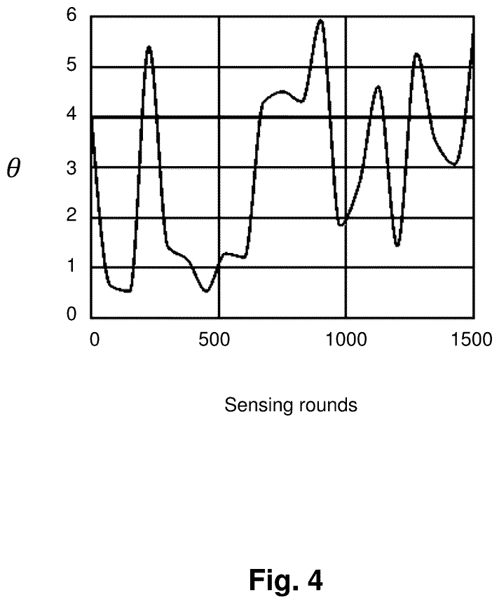

One such rotation function θₖ(t) is illustrated with respect to FIG. 4, however the function shown in FIG. 4 is merely illustrative and not intended to be limiting.

The rotation θ may then be applied by the transmitter by changing the Cross-Spectral Density (CSD) matrix in the transmitter chain, as described in International Patent Application PCT/CN2023/101544, incorporated herein by reference.

One problem with this approach, is that the θₖ(t) needs to be defined and known by both the initiator and any authorized responder, without being compromised such that it would be available to a potential eavesdropper.

According to at least some embodiments of the present disclosure, this problem is solved by deriving a symmetric private key for Sensing Privacy Protection (SPP) and use the private key to compute parameters of an SPP function. For example, a symmetric private key may be used to derive parameters that specify a time-varying function θₖ(t) that cannot be compromised by a 3rd party. Notably, the present disclosure is not limited to functions such as θₖ(t), but to other functions which may be used to modify a signal at an initiator.

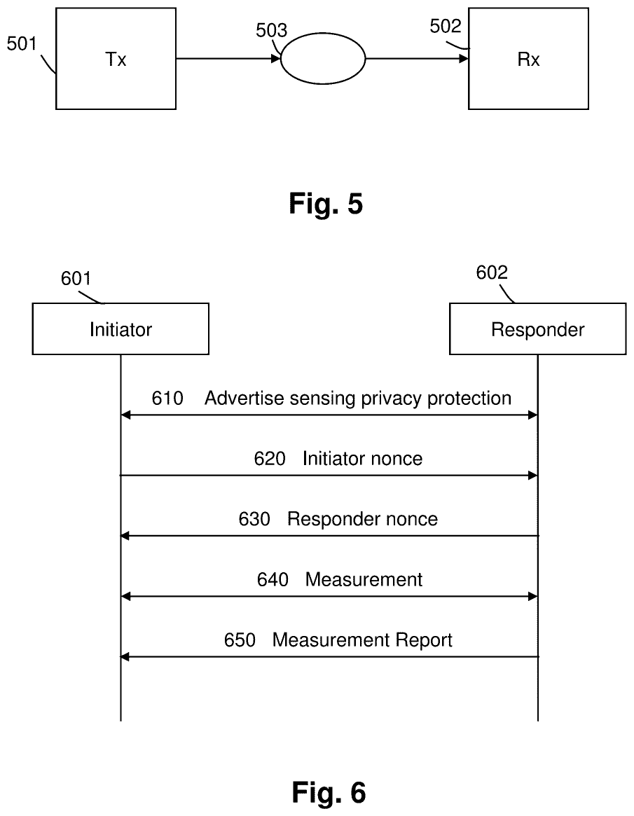

Reference is now made to FIG. 5 which shows a simple sensing system. As seen in FIG. 5, the system comprises an initiator 501, a responder 502, and a target 503. The responder 502 sends a message to the initiator 501 requesting a sensing measurement. The initiator 501 then sends a sensing measurement signal to the receiver 502 and the characteristics of that sensing measurement signal are modified by any objects, such as the target 503, that stands in the path between them. Such characteristics may include, but are not limited to, power, phase, and frequency.

### Mutually Derived Key

According to at least some embodiments of the present disclosure, a symmetric private key is derived through an information exchange between a responder and an initiator. For example, the responder and the initiator may use enhanced IEEE 802.11bf Sensing Measurement Setup Request and Sensing Measurement Setup Response frames to establish a mutually known secret key. Knowledge of the secret key allows the initiator and the responder to perform wireless sensing without allowing eavesdroppers to obtain information from the resulting signals.

In order to protect the communications leading to the establishment of the secret key from being compromised, conventional encryption techniques may be utilized. For example, Protected Management Frames (PMF) may be negotiated between the receiver and the transmitter. In some embodiments, IEEE 802.11 security association mechanisms may be used, such as Robust Security Network Association (RSNA) and Pre-Association Security Negotiation (PASN).

As illustrated in FIG. 6, a responder 602 and an initiator 601 may advertise their support for sensing privacy protection at 610.

As shown by arrow 620, the initiator may then send the sensing transmitter a first nonce. In some embodiments, the first nonce is transmitted in a Sensing Measurement Request Frame. The first nonce may be generated by the sensing receiver using any suitable random number generator.

Upon receiving the first nonce, the responder 602 may then generate a second nonce. As responder 602 now has both first and second nonces, it may derive a key using both nonces. Responder 602 may then send initiator 601 the second nonce. For example, the second nonce may be transmitted in a Sensing Measurement Response Frame, as illustrated by arrow 630, thereby initiator 601 to also derive the key using both nonces.

According to at least some embodiments, the key may be derived using the following formula:

SPP-Key-Input=HMAC-SHA-XXX(min(Nonce1,Nonce2)∥max(Nonce1,Nonce2));key=PRF-XXX(SPP-Key-Input,“Sensing Privacy Key”,min(MAC_R,MAC-I), max(MAC_R,MAC_I));
where XXX denotes the hash length (e.g. 256 bits), Nonce1 is the first nonce, Nonce2 is the second nonce, MAC_I is the MAC address of the initiator, and MAC_R is the MAC address of the responder. PRF is a Pseudo-Random Function, which also takes in as input a string (for example “Sensing Privacy Key”) to increase the entropy of the output.

Once the key is derived by both the initiator and the responder, sensing with privacy protection may begin. Specifically, the key may be used by both the initiator and the responder to parameterize a transformation function T. Thereafter, a signal S transmitted by the transmitter is transformed by the transformation function prior to transmission, such that the signal that is transmitted is T(S). Upon receiving the signal, the receiver applies the reverse of the function T, T⁻¹, to the received signal. The receiver then obtains T⁻¹(T(S))=S. The characteristics of the signal S are then analyzed to perform WLAN sensing.

According to at least some embodiments, T is a rotation function, which rotates a signal by an amount θ, where θ is computed as a function of time. In such embodiments, the inverse function T⁻¹ corresponds to the rotation of the signal by −θ.

Thus, as illustrated by arrow 640, the initiator sends a signal to the responder to perform WLAN sensing. This signal has been transformed based on the transformation function T, as discussed above. Upon receiving this signal, the responder applies the inverse of the transformation function T⁻¹ to the signal.

The responder may then analyze various characteristics of the signal and send the results to the initiator as illustrated by arrow 650. The initiator may then use these characteristics to make a determination with respect to a target.

Accordingly, an initiator and a responder may negotiate a key to be used to parameterize a transformation function, and apply the transformation function and its inverse to a signal in order to provide WLAN sensing protection.

### Initiator Derived Key

According to at least some embodiments of the present disclosure, the key is derived by the initiator and transmitted to the responder. For example, the key may be transmitted in a Sensing Measurement Setup Request Frame. In order to protect the key, conventional encryption techniques may be used. For example, PMF may be utilized.

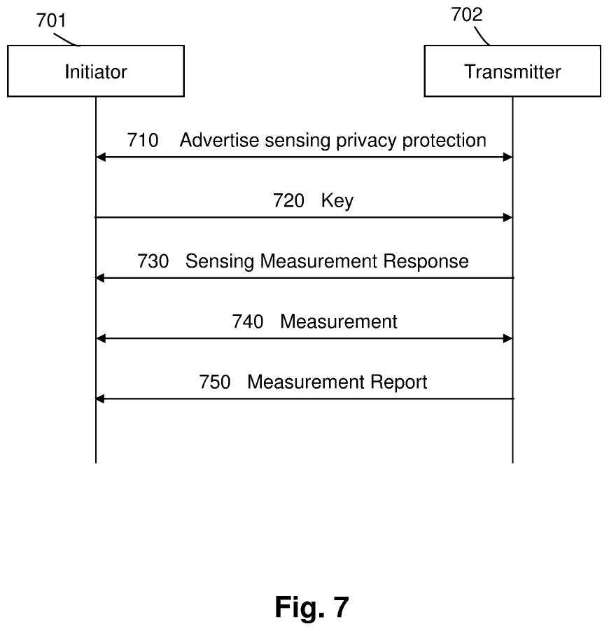

As illustrated in FIG. 7, a responder 702 and an initiator 701 may advertise their support for sensing privacy protection at 710.

The initiator 701 may then compute or select a suitable key using appropriate means. As shown by arrow 720, initiator 701 may then send the key to the responder 702. For example, the key may be sent in a Sensing Measurement Setup Request frame. The key may be encrypted using conventional means, such as Pairwise Transient Key Security Association (PTKSA), for example.

Upon receiving the key, the responder 702 may then respond with a Sensing Measurement Response, as illustrated by arrow 730. As both the receiver and the transmitter now share a key, they may use that key to parameterize a transformation function T, and perform WLAN sensing as described above with WLAN sensing protection. Specifically, the initiator may apply the transformation function to its outgoing signals, illustrated by arrow 740, and the responder may apply the reverse of the transformation function to its incoming signals. The responder may then issue a measurement report, as illustrated by arrow 750.

### Function Derivation From Key

According to at least some embodiments of the present disclosure, the transformation function T is a rotation function θₖ(t). The rotation function θₖ(t) may be derived using M random numbers between 0 and 2π. The M random numbers V₁ . . . V_{M} are then used to parameterize the function θₖ(t). In one embodiment, θₖ(t)=V₁+V₂X+V₃X²+ . . . +V_{M}X^{(M-1)}, however this is provided for illustrative purposes and is not intended to be limiting.

The ideal value for M is application specific. However, a typical value for M may be 20.

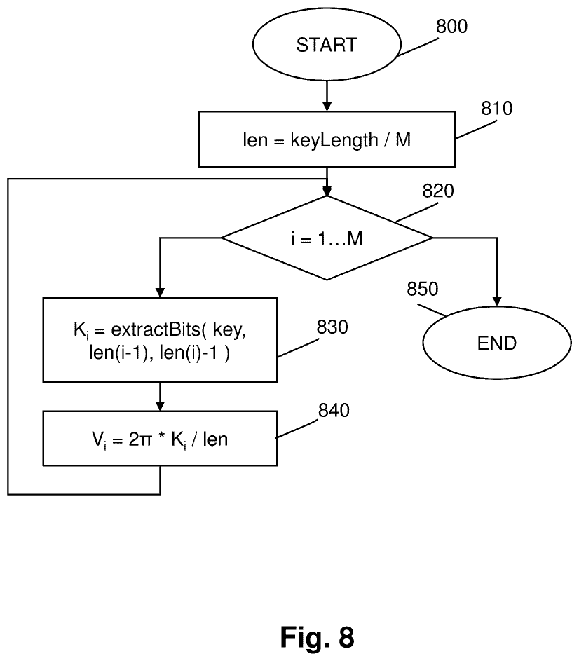

According to at least some embodiments of the present disclosure, the M random numbers are derived from the key as illustrated in FIG. 8.

The process starts at block 800 and proceeds to block 810 in which the key length is divided by M. The key length is the number of bits in the key. For example, the key length may be 256 bits and M may be 8, but the present disclosure is not intended to be limiting in this respect. Based on these example values, the value calculated at block 810 will be 32. This value represents the length of key segments that will be extracted from the key. In other words, the 256-bit key will be separated in 8 distinct 32-bit values.

The process then moves on to block 820 to perform a loop M times. At block 830, the i-th value is extracted from the key, where i is an index that increases by one at every iteration. Using the values from the above example, at a first iteration the value extracted from the key would correspond to bits 0 to 31 of the key, at the second iteration the value extracted from the key would correspond to bits 32 to 63, and so on.

At block 840, the value extracted from the key is mapped to a scaling value between 0 and 2π, Vᵢ, using the following equation:

$${V}_{i} = 2 π ( \frac{{K}_{i}}{{2}^{l}} )$$

where l represents the number of bits extracted from the key at each iteration, and Kᵢ represents bits extracted at iteration i.

The process then returns to block 820 and when M scaling values have been computed, the process ends at block 850.

Relationship between M and the Key Length

Given that the rotation function is derived using M random variables between 0 and 2π, the key size needs to be sufficiently long to provide entropy for the random variable values. Also, as the value for M is application dependent, the key size and the value of M may be negotiated, in some embodiments.

According to at least some embodiments of the present disclosure, the value M and the key size may be selected from Table 1 below, which is provided as a non-limiting example:

TABLE 1

| Bits of entropy | Key size | M |
|---|---|---|
| 64 | 256 | 4 |
| 32 | 256 | 8 |
| 32 | 384 | 12 |
| 24 | 384 | 16 |
| 25 | 512 | 20 |
| 16 | 512 | 32 |

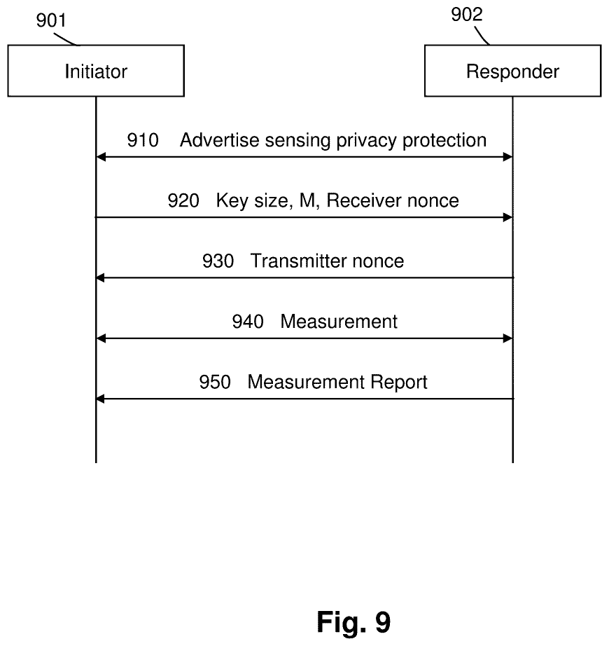

Further, according to at least some embodiments of the present disclosure, the key size and the value for M maybe negotiated as illustrated with respect to FIG. 9.

Specifically, a responder 902 and an initiator 901 may advertise their support for sensing privacy protection at 910.

The initiator 901 may then select a key size, a value for M, and compute a nonce using a suitable random number generator. The key size and the value for M may be selected based on Table 1 above, or based on the specific privacy protection needs of the application. The greater the bits of entropy, the greater the achievable level of security.

As shown by arrow 920, initiator 901 may then send the key size, the value for M, and the nonce to responder 902. For example, this information may be sent in a Sensing Measurement Setup Request frame. This message may be encrypted using PTKSA, or other suitable means.

Responder 902 receives this information and generates its own nonce. With its own nonce and the nonce received from initiator 901, responder 902 may then generate a key of the specified size. Responder 902 may also use the value M to derive scaling values for parameterizing a transformation function, such as for example a rotation function θₖ(t), as described above with respect to FIG. 8. According to at least some embodiments, responder 902 may respond to initiator 901 with a different value for M. Initiator 901 and responder 902 may then proceed using this different value for M.

Responder 902 then sends its own nonce to initiator 901, as illustrated by arrow 930. Upon receiving the responder's nonce, initiator 901 may then also generate a key of the specified size, and use the value M to derive scaling values for the transformation function.

As both initiator 901 and responder 902 are in possession of the same transformation function, they may start performing measurements for WLAN sensing by applying the transformation function to signals at the initiator, and the reverse of the transformation function to signals at the responder, as illustrated by arrow 940.

Responder 902 may then provide a measurement report, as illustrated by arrow 950.

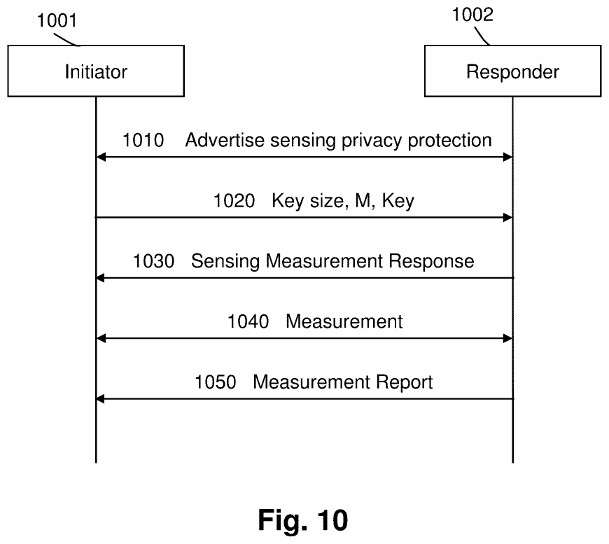

According to at least some embodiments of the present disclosure, the key is derived by the receiver and shared with the transmitter, as illustrated with respect to FIG. 10.

Specifically, a responder 1002 and an initiator 1001 may advertise their support for sensing privacy protection at 1010.

The initiator 1001 may then select a key size, a value for M, and compute a key of the selected size. The key size and the value for M may be selected based on Table 1 above, or based on the specific privacy protection needs of the application. The greater the bits of entropy, the greater the achievable level of security.

As shown by arrow 1020, initiator 1001 may then send the key size, the value for M, and the key to responder 1002. In some embodiments, the key size may be omitted and observed from the received key at the responder. For example, this information may be sent in a Sensing Measurement Setup Request frame. This message may be encrypted using PTKSA, or other suitable means.

Upon receiving the key, the responder 1002 may then respond with a Sensing Measurement Response, as illustrated by arrow 1030. As both the receiver and the transmitter now share a key, the key size, and a value for M, they may use that key to parameterize a transformation function T, and perform WLAN sensing as described above with WLAN sensing protection.

Specifically, initiator 1001 and responder 1002 may derive M scaling values from the key as illustrated above with respect to FIG. 8. With the M scaling values, each of initiator 1001 and responder 1002 have knowledge of the transformation function. Initiator 1001 may then apply the transformation function to its outgoing signals, as illustrated by arrow 1040, and responder 1002 may apply the reverse of the transformation function to its incoming signals. The responder may then issue a measurement report, as illustrated by arrow 1050.

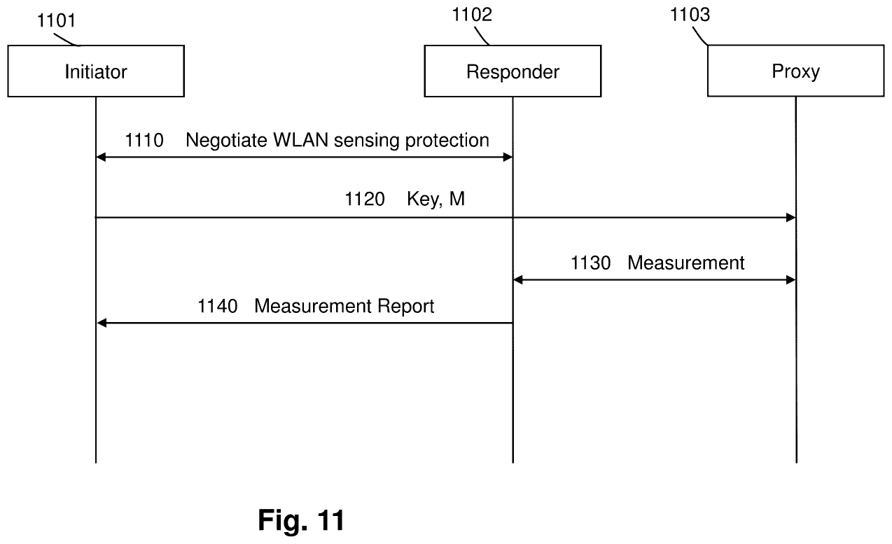

While the above describes a method of negotiating WLAN sensing protection between an initiator and a responder, the present disclosure may be applied in other contexts also. For example, in some embodiments of the present disclosure, the initiator uses a proxy device to transmit the sensing measurement signal to the responder. In this embodiment, the initiator requires a security relationship with the proxy so that the key can be shared between them. This embodiment may be used in cases where the initiator is not capable of transmitting a sensing measurement signal by itself. Such an embodiment is illustrated with respect to FIG. 11.

Specifically, in FIG. 11, an initiator 1101, a responder 1102, and a proxy 1103 are shown. The initiator 1101 and the responder 1102 may negotiate WLAN sensing protection, as illustrated by arrow 1110. Specifically, this may entail initiator 1101 and responder 1102 to agree to a key and a transformation function based on the key, as described above.

Then, as illustrated by arrow 1120, initiator 1101 may provide the key to the proxy 1103. As discussed above, initiator 1101 and proxy 1103 have a security relationship so that the key is encrypted. Initiator 1101 may also provide proxy 1103 with the value for M, to allow the proxy to derive the transformation function from the key. In some embodiments, the value for M may be predetermined and known by the proxy so that it is not transmitted.

Proxy 1103 may then transmit measurement signals that are analyzed by responder 1102 as illustrated by arrow 1130. The measurement signals are transformed prior to transmission based on the transformation function and the inverse of the transformation function is applied by responder 1102 to received signals.

Responder 1102 may then provide a measurement report to the initiator as illustrated by arrow 1140.

According to yet another embodiment, the responder may initiate the key derivation, either mutually or by transmitting it to the initiator. This embodiment may be useful when the initiator wishes to implement privacy, but is not capable of deriving a key for itself.

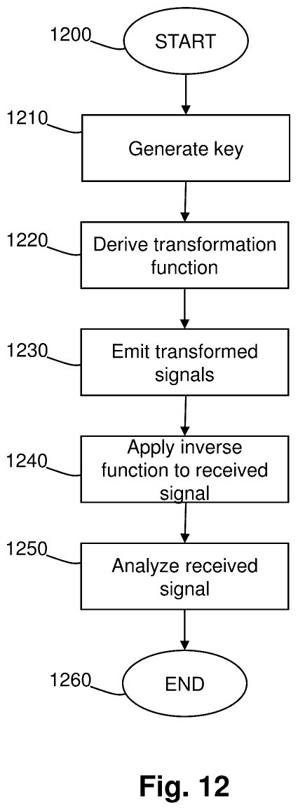

According to yet another embodiment, the initiator and responder are the same device. In this case, although the constellation may be rotated to provide privacy, there is no requirement to transmit keys from one device to another, although a key and a transformation function may still be derived internally within the device. Such an embodiment is illustrated with respect to FIG. 12.

As seen in FIG. 12, the process starts at block 1200 and proceeds to block 1210 where a key is generated. The process then moves on to block 1220 where a transformation function is derived from the key. For example, the transformation function may be derived by extracting M scaling values from the key as illustrated with respect to FIG. 8.

The process then moves on to block 1230 where a measurement signal is transmitted. The measurement signal is transformed with the transformation function prior to transmission.

The process then moves on to block 1240 where the device receives the measurement signal. For example, the signal may have bounced off of a target prior to returning to the device. The device receives the returning signal and applies the inverse of the transformation function to the received signal.

The process then moves on to block 1250 where the device analyzes the received signal to which the inverse of the transformation function has been applied, to obtain information on the target. The process then moves on to block 1260 and ends.

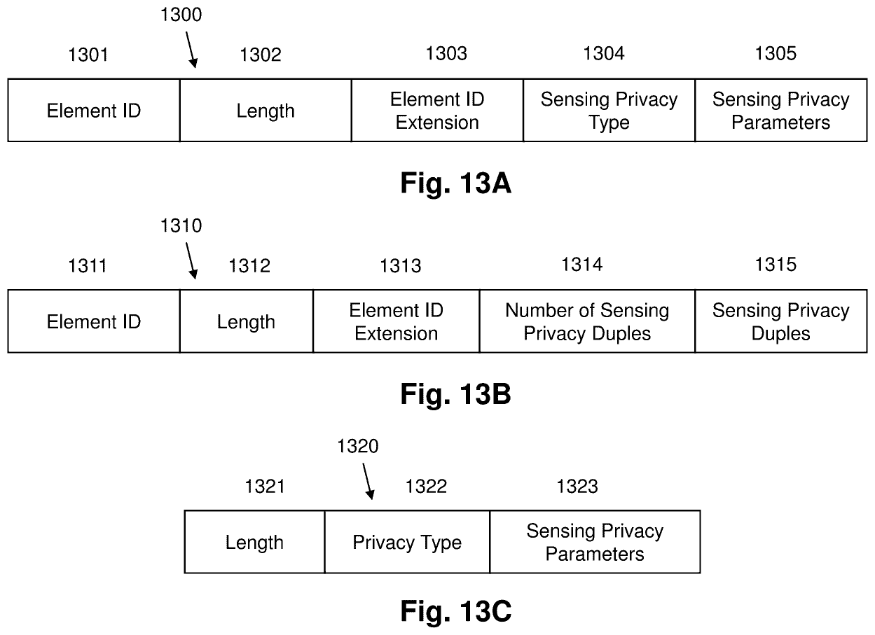

The above may be implemented using a new privacy element, illustrated with respect to FIG. 13A. Specifically, as seen in FIG. 13A, a privacy element 1300 comprises an Element ID field 1301, a length field 1302, an Element ID Extension field 1303, a Sensing Privacy Type field 1304, and a Sensing Privacy Parameters field 1305. The Element ID field 1301, Length field 1302, and Element ID Extension field 1303 are defined by IEEE 802.11 and IEEE 802.11bf. The privacy element 1300 may be appended to a Sensing Measurement Request frame, a Sensing Measurement Response frame, or a Sensing Measurement Setup frame.

The Sensing Privacy Type field defines the privacy protocol that may be used between the initiator and the responder, as shown in Table 2 below.

TABLE 2

| Value | Sensing Privacy Type |
|---|---|
| 0 | Not supported |
| 1 | Constellation Rotation |
| 2 | Future Schemes |
| 3-6 | Reserved |
| 7 | Vendor Specific |

According to at least some embodiments of the present disclosure, the value 1 may be used to represent the constellation rotation mechanism described herein. Other values are suggested for future sensing privacy schemes and a value is allocated for a vendor specific scheme. The value α may be used to indicate that no sensing privacy scheme is supported by the device.

For a vendor specific Sensing Privacy Type, an Organizationally Unique Identifier (OUI) may be included within the Sensing Privacy Parameters field 1305 to identify the vendor. If a vendor supports more than one privacy protocol, a specific protocol may be indicated with the OUI and a protocol index, such that the combination of the OUI and the index uniquely identifies a protocol.

The Sensing Privacy Parameters field 1305 contains information pertinent to the privacy scheme, such as nonces, keys, or a value for M, amongst others.

Reference is now made to FIG. 13B, which illustrates an alternative privacy element 1310. Privacy element 1310 also includes an Element ID field 1311, a length field 1312, and an Element ID Extension field 1313. Privacy element 1310 further includes field 1314 for indicating a number of Privacy Sensing Tuples, and a field 1315 for the Privacy Sensing Tuples. Each tuple indicates a Sensing Privacy Type and its associated parameters, as illustrated with respect to FIG. 13C.

As seen in FIG. 13C, a privacy tuple 1320 is illustrated. Privacy tuple 1320 may be used in a privacy element as illustrated in FIG. 13B, and includes a length field 1321, a Sensing Privacy Type field 1322, and a Sensing Privacy Parameters field 1322.

Therefore, using the privacy element of FIG. 13B and the privacy tuple of FIG. 13C, an initiator and a responder may exchange parameters for multiple sensing privacy types simultaneously.

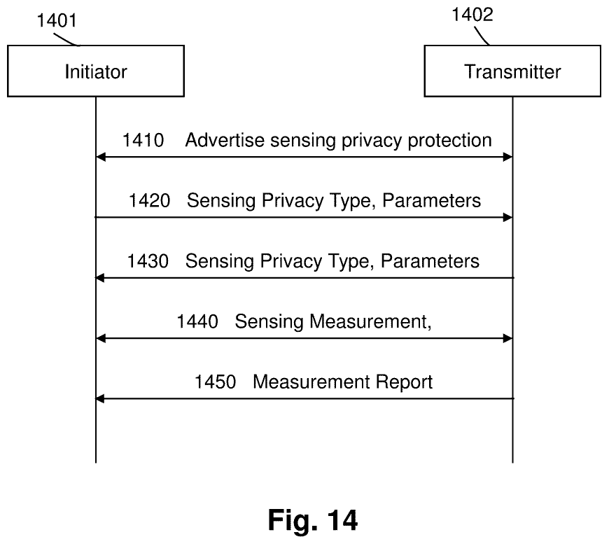

Reference is now made to FIG. 14, which illustrates a process for WLAN sensing privacy based on the above.

Specifically, as seen in FIG. 14, an initiator 1401 and a responder 1402 may advertise their WLAN sensing protection capability, as illustrated by arrow 1410. According to at least some embodiments, each of initiator 1401 and responder 1402 may indicate a list of Sensing Privacy Types which are supported.

Then, as illustrated by arrow 1420, initiator 1401 may initiate WLAN sensing by transmitting a WLAN sensing protection type and parameters to responder 1402. For example, initiator 1401 may send a Sensing Measurement Request frame with a privacy element as illustrated with respect to FIG. 13A or 13B. The privacy element may indicate a Sensing Privacy Type, such as constellation rotation, or others, and parameters. The parameters may comprise, without limitation a nonce, a key length, a value for M, and a key, amongst others.

Then, as illustrated by arrow 1430, responder 1402 may respond with a message acknowledging the Sensing Privacy Type requested by initiator 1401, and provide parameters, as needed. For example, when initiator 1401 provides a nonce at 1420, responder 1402 may provide its own nonce at 1430. Alternatively, when initiator 1401 provides a key at 1420, responder 1402 may simply respond with confirmation that the key was received without providing additional parameters.

After responder 1402 responds at 1430, both initiator 1401 and responder 1402 share a key, as well as the necessary information to derive a transformation function from the key. For example, the parameter M may have been transmitted by initiator at 1420, or may be predetermined. Both initiator 1401 and responder 1402 may then derive the transformation function, which may be for example a rotation function as described above.

Then, as indicated by arrow 1440, initiator 1401 may transmit a measurement signal transformed by the transformation function, and responder 1402 may receive the measurement signal and apply the inverse of the transformation function to the received signal. Responder 1402 may then analyze the received and transformed signal to produce a measurement report, which is transmitted back to the initiator as illustrated by arrow 1450.

According to at least some embodiments, the measurement report may include a privacy element requesting a change in the parameters used in WLAN sensing privacy.

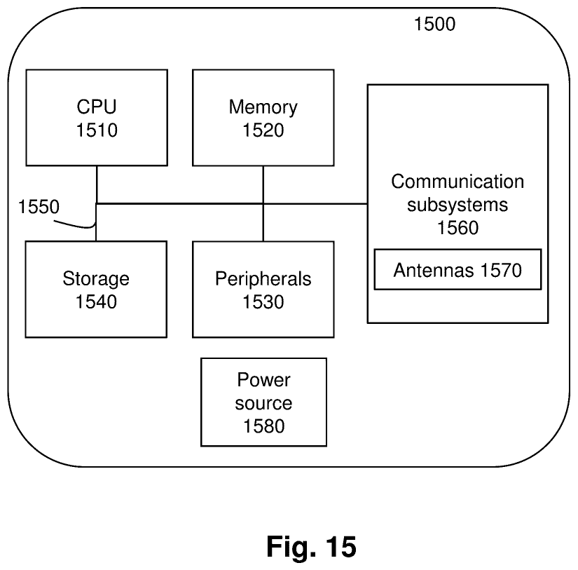

The above functionality may be implemented on any one or combination of computing devices. FIG. 15 is a block diagram of a computing device 1500 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 1500 may comprise a central processing unit (CPU) 1510, memory 1520, a mass storage device 1540, and peripherals 1530. Peripherals 1530 may comprise, amongst others one or more input/output devices, such as a speaker, microphone, mouse, touchscreen, keypad, keyboard, printer, display, network interfaces, and the like. Communications between CPU 1510, memory 1520, mass storage device 1540, and peripherals 1530 may occur through one or more buses 1550.

The bus 1550 may be one or more of any type of several bus architectures including a memory bus or memory controller, a peripheral bus, video bus, or the like. The CPU 1510 may comprise any type of electronic data processor. The memory 1520 may comprise any type of system memory such as static random-access memory (SRAM), dynamic random-access memory (DRAM), synchronous DRAM (SDRAM), read-only memory (ROM), a combination thereof, or the like. In an embodiment, the memory 1520 may include ROM for use at boot-up, and DRAM for program and data storage for use while executing programs.

The mass storage device 1540 may comprise any type of storage device configured to store data, programs, and other information and to make the data, programs, and other information accessible via the bus. The mass storage device 1540 may comprise, for example, one or more of a solid-state drive, hard disk drive, a magnetic disk drive, an optical disk drive, or the like.

The computing device 1500 may also include one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

In particular, example clauses may include:

A. A method at a responder device, comprising: establishing a symmetric key with an initiator; deriving a transformation function from the symmetric key; receiving a measurement signal from the initiator; applying an inverse of the transformation function to the measurement signal; analyzing the transformed signal to produce a measurement report; and transmitting the measurement report to the initiator.

By transforming signals prior to transmission, eavesdroppers may not analyze the WLAN sensing signals, thereby protecting the privacy of the WLAN sensing target. The authorized responder may apply the inverse of the transformation function to the received signals in order to analyze the WLAN sensing signals.

B. The method of clause A, wherein establishing the symmetric key comprises: receiving a first nonce and a key size from the initiator; computing a second nonce; transmitting the second nonce to the initiator; and deriving the symmetric key having the key size from the first nonce and the second nonce.

The symmetric key may be established based on a nonce from the initiator and a nonce from the responder. The initiator may also indicate a key size.

C. The method of clause A, wherein establishing the symmetric key comprises: receiving the symmetric key from the initiator.

The symmetric key may be established by the initiator computing a key, and sharing it with the responder.

D. The method of clause A, wherein the transformation function is a constellation rotation function, wherein the amount of rotation is a function θₖ(t) of a time t.

The transformation function may be a constellation rotation function. The constellation rotation function varies over time such that different rotations are applied at different time intervals.

E. The method of clause D, wherein the θₖ(t) function is parameterized using M values extracted from the symmetric key, where M is an integer known by the initiator and by the responder.

The θₖ(t) function is parameterized based on values extracted from the symmetric key. Therefore, knowledge of the symmetric key, and knowledge of the algorithm used to parameterize the θₖ(t) function from the symmetric key, allows both the initiator and the responder to have knowledge of the θₖ(t) function.

F. The method of clause E, further comprising receiving the value of M from the initiator.

The value of M may be transmitted by the initiator to the responder during setup.

G. The method of clause E, wherein the value of M is predetermined.

The value of M may be predetermined and known by both the initiator and the responder.

H. The method of clause E, wherein the M values are extracted from the symmetric key by selecting L bits from the symmetric key, wherein L is determined by dividing a length of the symmetric key in bits by M, to produce a first value; and scaling the first value to a second value between 0 and 2π.

The M values used to parameterize the transformation function may be extracted by extracting M sets of bits of equal size from the symmetric key, and scaling the resulting number to a value between 0 and 2π.

I. The method of clause A, further comprising, indicating, to the initiator, WLAN sensing protection capabilities of the responder.

J. A computing device comprising a processor and a communications subsystem, wherein the processor and the communications subsystem cooperate to: establish a symmetric key with an initiator; derive a transformation function from the symmetric key; receive a measurement signal from the initiator; apply an inverse of the transformation function to the measurement signal; analyze the transformed signal to produce a measurement report; and transmit the measurement report to the initiator.

K. The computing device of clause J, wherein establishing the symmetric key comprises: receiving a first nonce and a key size from the initiator; computing a second nonce; transmitting the second nonce to the initiator; and deriving the symmetric key having the key size from the first nonce and the second nonce.

L. The computing device of clause J, wherein establishing the symmetric key comprises: receiving the symmetric key from the initiator.

M. The computing device of clause J, wherein the transformation function is a constellation rotation function, wherein the amount of rotation is a function θₖ(t) of a time t.

N. The computing device of clause M, wherein the θₖ(t) function is parameterized using M values extracted from the symmetric key, where M is an integer known by the initiator and by the responder.

O. The computing device of clause N, wherein the processor and the communications subsystem further cooperate to receive the value of M from the initiator.

P. The computing device of clause N, wherein the value of M is predetermined.

Q. The computing device of clause N wherein the M values are extracted from the symmetric key by selecting L bits from the symmetric key, wherein L is determined by dividing a length of the symmetric key in bits by M, to produce a first value; and scaling the first value to a second value between 0 and 2π.

R. The computing device of clause J, wherein the processor and the communications subsystem further cooperate to indicate, to the initiator, WLAN sensing protection capabilities of the responder.

S. A computer readable medium having stored thereon executable code for execution on a processor of an initiator device, the executable code comprising instructions for establishing a symmetric key with an initiator; deriving a transformation function from the symmetric key; receiving a measurement signal from the initiator; applying an inverse of the transformation function to the measurement signal; analyzing the transformed signal to produce a measurement report; and transmitting the measurement report to the initiator.

T. A method at a device for WLAN sensing protection comprising: establishing a key; deriving a transformation function from the key; applying the transformation function to a measurement signal; transmitting the measurement signal; receiving the measurement signal; applying an inverse of the transformation function to the received signal; and analyzing the transformed signal.

1. A method at an initiator for Wireless Local Area Network (WLAN) sensing protection, comprising:
establishing a symmetric key with a responder;
deriving a transformation function from the symmetric key;
applying the transformation function to a signal;
transmitting the signal; and
receiving a measurement report from the responder based on the signal.

2. The method of claim 1, wherein establishing the symmetric key comprises:
transmitting a first nonce and a key size to the responder;
receiving a second nonce from the responder; and
deriving the symmetric key having the key size from the first nonce and the second nonce.

3. The method of claim 1, wherein establishing the symmetric key comprises:
computing a symmetric key at the initiator; and
transmitting the symmetric key to the responder.

4. The method of claim 1, wherein the transformation function is a constellation rotation function, wherein the amount of rotation is a function θₖ(t) of a time t.

5. The method of claim 4, wherein the θₖ(t) function is parameterized using M values extracted from the symmetric key, where M is an integer known by the initiator and by the responder.

6. The method of claim 5, wherein M is selected by the initiator and transmitted to the responder.

7. The method of claim 5, wherein M is predetermined.

8. The method of claim 5, wherein the M values are extracted from the symmetric key by:
selecting L bits from the symmetric key, wherein L is determined by dividing a length of the symmetric key in bits by M, to produce a first value;
scaling the first value to a second value between 0 and 2π.

9. The method of claim 1, further comprising, indicating, to the responder, WLAN sensing protection capabilities of the initiator.

10. A computing device for Wireless Local Area Network (WLAN) sensing protection, comprising:
a processor; and
a communications subsystem;
wherein the processor and the communications subsystem cooperate to:
establish a symmetric key with a responder;
derive a transformation function from the symmetric key;
apply the transformation function to a signal;
transmit the signal; and
receive a measurement report from the responder based on the signal.

11. The computing device of claim 10, wherein establishing the symmetric key comprises:
transmitting a first nonce and a key size to the responder;
receiving a second nonce from the responder; and
deriving the symmetric key having the key size from the first nonce and the second nonce.

12. The computing device of claim 10, wherein establishing the symmetric key comprises:
computing a symmetric key at the computing device; and
transmitting the symmetric key to the responder.

13. The computing device of claim 10, wherein the transformation function is a constellation rotation function, wherein the amount of rotation is a function θₖ(t) of a time t.

14. The computing device of claim 13, wherein the θₖ(t) function is parameterized using M values extracted from the symmetric key, where M is an integer known by the computing device and by the responder.

15. The computing device of claim 14, wherein M is selected by the computing device and transmitted to the responder.

16. The computing device of claim 14, wherein M is predetermined.

17. The computing device of claim 14, wherein the M values are extracted from the symmetric key by:
selecting L bits from the symmetric key, wherein L is determined by dividing a length of the symmetric key in bits by M, to produce a first value;
scaling the first value to a second value between 0 and 2π.

18. The computing device of claim 10, further comprising, indicating, to the responder, WLAN sensing protection capabilities of the computing device.

19. A computer readable medium, having stored thereon executable code for execution on a processor of an initiator device, the executable code comprising instructions for:
establishing a symmetric key with a responder;
deriving a transformation function from the symmetric key;
applying the transformation function to a signal;
transmitting the signal; and
receiving a measurement report from the responder based on the signal.
